(19) United States
(12) Patent Application Publication
(10) Pub. No.: US 2005/0086149 A1
(43) Pub. Date: Apr. 21, 2005

(54) Credit risk hedging system, method and apparatus

(76) Inventors: Paul Efron, Larchmont, NY (US); Tamilla Ghodsi, New York, NY (US); James Brower, New York, NY (US)

Correspondence Address: BUCKLEY, MASCHOFF, TALWALKAR LLC, 5 ELM STREET, NEW CANAAN, CT, 06840, US

(21) Appl. No.: 11/006,441

(22) Filed: Dec. 7, 2004

(51) Int. Cl. G06F 17/60

(52) U.S. Cl. 705/36

(57) ABSTRACT

Systems, methods, apparatus, computer program code and means for hedging credit risk associated with a leveraged lease equity transaction are provided.

### BACKGROUND

Embodiments relate to systems, methods and apparatus for hedging. More particularly, embodiments of the present invention relate to systems, methods and apparatus for hedging leveraged lease equity (“LLE”) credit risk. In some embodiments, credit risk is hedged by entering into transactions with third party investors unaffiliated with the underlying parties to the leveraged lease.

Leveraged lease financing is a technique that has been used to provide benefits to companies that own or use high value capital equipment (such as aircraft, power plants, etc.). Unfortunately, due to losses in the power and airline industries, LLE investors are becoming less willing to make investments. LLE investors are particularly unwilling to make investments in the high yield sector. High yield companies are ideal candidates for lease financing as they are frequently not taxpayers and can benefit from the lower financing cost and clean balance sheet treatment of leases.

One technique used to provide a partial hedge against loss associated with leveraged leases is the use of so-called “deficiency agreements.” A typical deficiency agreement is provided by a party to a leveraged lease transaction in conjunction with a reimbursement agreement. Unfortunately, existing deficiency agreements do not provide an efficient hedge, are not set up to accommodate investment or participation by unaffiliated third parties, and have drawn out and uncertain conditions to payment.

It would be desirable to provide techniques for hedging credit risk associated with LLE investments. It would further be desirable to provide techniques that are attractive to third party investors and which have clear and definite conditions triggering payment obligations.

### BRIEF DESCRIPTION OF THE DRAWINGS

FIG. 1 is a block diagram of one embodiment of a transaction consistent with some embodiments.

FIG. 2 is a block diagram of a further embodiment of a transaction consistent with some embodiments.

FIG. 3 is a block diagram of a further embodiment of a transaction consistent with some embodiments.

FIGS. 4-5 are flow diagrams illustrating exemplary processes for credit risk hedging pursuant to some embodiments.

FIG. 6 is a block diagram of a device pursuant to some embodiments.

### DETAILED DESCRIPTION

According to some embodiments, systems, methods, apparatus, computer program code, and means are provided for performing a credit risk hedging transaction. Applicants have recognized a need for an ability to efficiently hedge credit risk associated with LLE investments. Pursuant to some embodiments, a credit risk hedging transaction includes two primary transactions: an LLE investment where a LLE investor receives a beneficial interest in an entity (“Entity”, such as a trust) in exchange for an LLE investment, and an agreement between a hedge counterparty and the LLE investor, where the LLE investor commits to transfer the beneficial interest in the Entity to the hedge counterparty upon the occurrence of a specified credit event.

Pursuant to some embodiments, the agreement between the LLE investor and the hedge counterparty is a swap agreement and the hedge counterparty is (a) a group of third party investors or (b) an issuer of a credit linked obligation or note to third party investors. Pursuant to some embodiments, the agreement between the LLE investor and the hedge counterparty is a letter of credit and the hedge counterparty is a lender (or a fronting bank for a group of third party investors). Pursuant to some embodiments the providers of the LLE credit protection are third parties unaffiliated with the parties in the underlying lease financing. Further details of each embodiment will be described further below.

Using such a credit risk hedging transaction, Applicants have provided a new and highly efficient hedge for LLE credit risk. Embodiments allow LLE investors in both investment and non-investment grade LLE transactions to hedge credit risk, thereby providing new and unanticipated opportunities for non-investment grade companies to obtain lease financing. With these and other advantages and features of the invention that will become hereinafter apparent, the nature of the invention may be more clearly understood by reference to the following detailed description of the invention, the appended claims and to the several drawings attached herein.

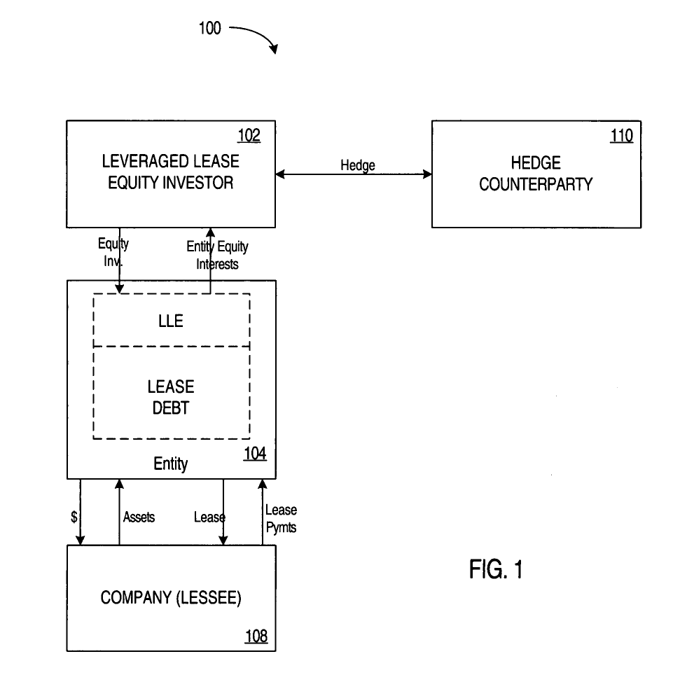

Features of embodiments will be described by first referring to FIG. 1, where a block diagram depicts a transaction 100 consistent with some embodiments. As shown, transaction 100 may involve the interaction of several entities or individuals, including a LLE investor 102, an Entity 104, a lessee (the “Lessee”) 108, and a hedge counterparty 110. In general, transaction 100 is structured to hedge credit risk associated with a lease investment by LLE investor 102. LLE investor 102 owns a beneficial interest in Entity 104. Entity 104 is set up to own one or more assets on lease (the “Lease”). Entity 104, acting as a lessor, leases the assets (the “Assets”) to Lessee 108 in exchange for Lease rental payments. Entity 104 both owns the Assets and the Lease. Those skilled in the art will understand that Entity 104 may be funded by issuing notes to one or more lenders. That is, Entity 104 may have Lease debt and Lease equity.

LLE investor 102 may be an entity such as a qualified investor that has sufficient funds to invest in Entity 104 in exchange for receiving ownership interests (“Entity Equity Interests”) in Entity 104 evidencing ownership of Entity 104. Pursuant to embodiments of the present invention, LLE investor 102 is now able to effectively hedge the credit risk associated with its investment in Entity 104. As will be described further below, LLE investor 102 hedges the credit risk by entering into a hedging transaction with hedge counterparty 110.

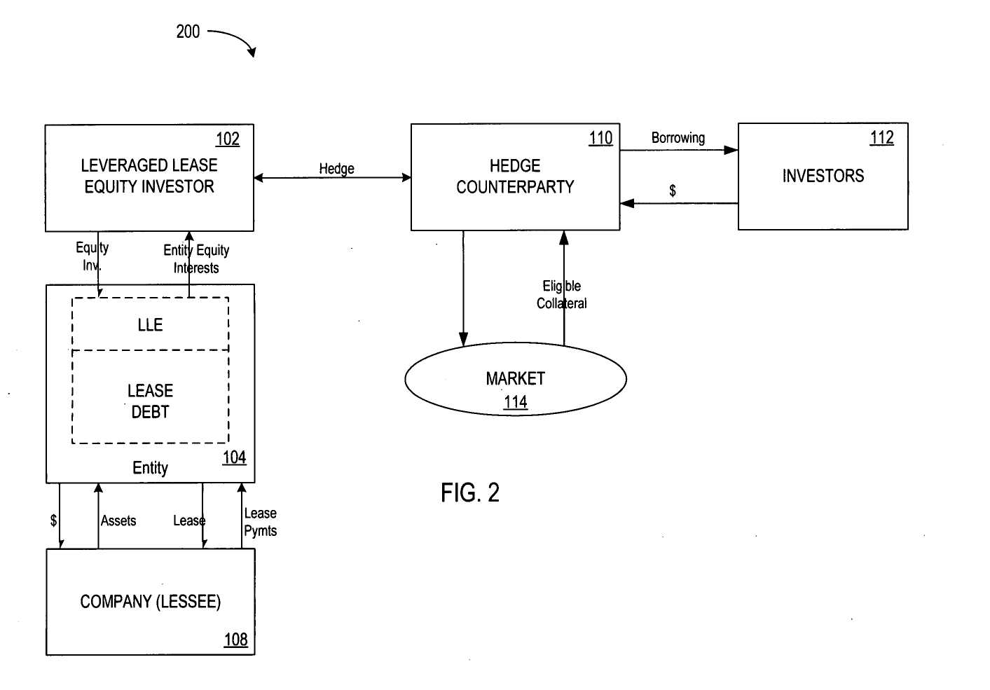

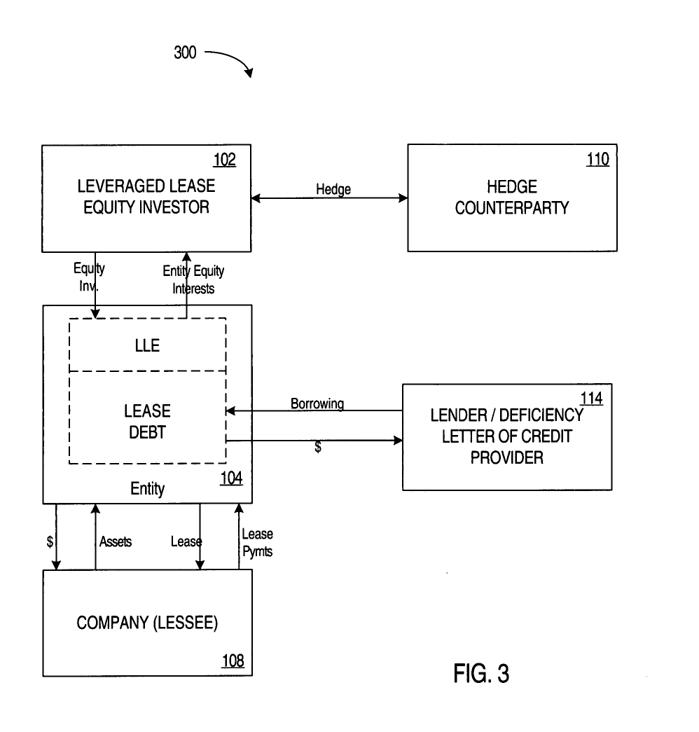

Hedge counterparty 110 may be any of a number of different types of entities, depending on the nature of the hedging transaction. For example, as will be described further below in conjunction with FIG. 2, hedge counterparty 110 may be third party investors or a special purpose vehicle or other entity set up by or on behalf of LLE investor 102, and the hedging transaction may be a swap agreement between the parties. As another example, as will be described further below in conjunction with FIG. 3, hedge counterparty 110 may be a financial institution or other entity and the hedging transaction may be the issuance of a letter of credit. Those skilled in the art, upon reading this disclosure, will recognize that other types of entity forms may also be used. In addition, those skilled in the art will recognize that other forms of hedging innovations may be used.

In general, pursuant to embodiments of the present invention, LLE investor 102 hedges credit risk associated with its LLE investment by entering into a hedging transaction with a hedge counterparty 110. Pursuant to some embodiments, the hedging transaction includes an obligation of the LLE investor 102 to deliver its Entity Equity Interests to the hedge counterparty 110 upon the occurrence of a specified credit event.

Pursuant to some embodiments, the specific credit events specified in the hedging transaction are selected to represent the events that most clearly present credit risk to a LLE investor 102, including: (1) the Chapter 11 bankruptcy of the Lessee and the notice of Lease termination by Entity or Lease debt holders; (2) the Chapter 11 bankruptcy of the Lessee and rejection of the Lease by Entity or the Lessee; (3) the failure to pay rent by the Lessee and notice of Lease termination by Entity or Lease debt holders; or (4) the Chapter 7 liquidation of the Lessee. In general, a credit event will be deemed to occur only if a specified credit event occurs. Applicants believe these credit events provide participants (including the hedge counterparty 110, etc.) with a relatively immediate, and readily ascertainable approach to triggering obligations associated with the hedging transaction. In this manner, LLE investors are more likely to enter into transactions pursuant to embodiments of the present invention, thereby providing increased opportunities for leveraged lease transactions.

Applicants have recognized that, for the purposes of hedging credit risk associated with a leveraged lease, bankruptcy in and of itself and on its own may be insufficient to qualify as a credit event, as, for example, in many situations, a Lessee may continue to pay rent on the Lease so that the Assets may continue to be used during bankruptcy. As such, true credit risk may only materialize when both bankruptcy and a rejection or foreclosure occurs. Pursuant to some embodiments, both the transaction between LLE investor 102 and hedge counterparty 110 and any subsequent transaction between hedge counterparty 110 and, for example, third party investors 112 (as described in the embodiment of FIG. 2) will include substantially the same definition of credit event.

Reference is now made to FIG. 2, where one embodiment of a transaction 200 pursuant to the present invention is shown. In the depicted transaction, LLE investor 102 enters into a hedging transaction with hedge counterparty 110, and hedge counterparty 110 enters into a borrowing agreement with one or more third party investors 112 and also acquires eligible collateral from market 114. For the purpose of describing the transaction of FIG. 2, the hedge counterparty 110 may be referred to as the “Hedge SPV 110”. In one specific embodiment, the hedge transaction between LLE investor 102 and hedge counterparty 110 is a swap agreement obligating the LLE investor 102 to deliver its Entity Equity Interests 104 to hedge counterparty 110 upon the occurrence of a specified credit event (as described above). LLE investor 102 pays hedge counterparty 110 an agreed-upon premium in exchange for the swap (or, in some embodiments, in exchange for a letter of credit).

Hedge counterparty 110 may be a separate entity, such as a limited liability company or similar entity. In one specific embodiment, hedge counterparty 110 is a special purpose limited liability company whose activities are purchasing assets, entering into derivative transactions and issuing matching limited recourse liabilities as described further herein. Those skilled in the art, upon reading this disclosure, will recognize that hedge counterparty 110 may be other types of entity forms.

In general, transaction 200 includes two components (after creation of the Entity 104 described above): a swap transaction between hedge counterparty 110 and LLE investor 102, and a transaction whereby hedge counterparty 110 issues an instrument (such as a loan or note) to one or more third party investors 112. Each of these transactions is structured to provide a hedge of credit risk associated with the Lease of Assets to Lessee 108. More particularly, the transactions are structured to pass Entity Equity Interests to third party investors 112 if one of a specified list of credit events occurs.

As discussed above, the specific credit events specified in the swap transaction and the instrument issued to the third party investors 112 are selected to represent the events that most clearly represent credit risk to an LLE investor 102. Pursuant to some embodiments, both the transaction between LLE investor 102 and hedge counterparty 110 and the transaction between hedge counterparty 110 and third party investors 112 include substantially the same definition of credit event.

The instrument issued to the (one or more) third party investors 112 permits hedge counterparty 110 to borrow funds to purchase collateral. The instrument may be, for example, loan certificates or medium term notes (for simplicity, either type of instrument will be referred hereinafter as a “note”). The proceeds of the issuance of the notes are invested in eligible collateral, such as AAA asset backed securities or any other form of collateral deemed suitable by third party investors 112.

The notes may be issued with a number of terms and conditions, including, in some embodiments, terms described below (in addition to the terms defining “credit events” described above). Those skilled in the art will appreciate that other terms (such as, for example, a trade date, settlement date, coupon payment dates, and other dates commonly used in similar agreements) and specification of events as “credit events” may also be provided.

| Term | Description |
|---|---|
| Principal Amount | A principal amount and a currency type is specified |
| | (e.g., such as U.S. dollars). The principal amount |
| | may amortize based on a specified schedule. |
| Repayment of | Terms specifying the repayment of principal will be |
| Principal | provided. For example, the terms may specify that |
| | the principal is repaid quarterly on specified |
| | payment dates in the amounts set forth in a payment |
| | schedule unless a credit event occurs. Further, upon |
| | the occurrence of a credit event, hedge counterparty |
| | 110 will deliver to third party investors 112 the |
| | Entity Equity Interests in satisfaction of the hedge |
| | counterparty's 110 obligations under the notes and |
| | no further principal payments will be required. |
| Termination | One or more termination events may be specified, |
| Events | including a termination event upon the payment in |
| | full of all obligations of Lessee 108 under the Lease |
| | upon an early termination of the Lease. |
| | Upon the occurrence of a termination event, third |
| | party investors 112 will be redeemed at the then- |
| | current outstanding principal amount of the note. |
| Issue Price | An issue price is specified. Generally, the issue price |
| | will be equal to 100% of the note. |
| Scheduled | Each note will have a scheduled maturity date. For |
| Maturity | example, the scheduled maturity date may be 10 |
| Date | years from the date of issue. |
| Maturity Date | A term will be provided specifying a maturity date. |
| | For example, the maturity date may be specified as |
| | the earlier of (i) the scheduled maturity date, or (ii) a |
| | certain number of days following a credit event or |
| | termination event. |
| Coupon | A coupon amount of the note is specified. For |
| | example, the coupon may be specified as being an |
| | amount equal to the interest received on the |
| | collateral plus the premium amount payable by LLE |
| | investor 102 under the swap. |
| Change in | Terms may also be provided specifying the |
| Control of | obligations upon a change in control of the Lessee |
| Reference Entity | |

The note also includes terms specifying the collateral and priority of creditors. For example, pursuant to some embodiments, the note issued to the third party investors 112 is secured by: (1) a perfected security interest in certain collateral, and (2) the hedge countparty's 110 rights under the swap agreement (described further below), including the right to receive, upon the occurrence of a specified credit event, both the premium and the Entity Equity Interests.

The note may also include terms specifying one or more transfer restrictions. Pursuant to some embodiments, the transfer restrictions include restrictions that are consistent with the terms of the Entity Equity Interests. Further, confidentiality restrictions may need to be incorporated to be consistent with those included in the Entity Equity Interests. In this manner, embodiments ensure that upon the occurrence of a credit event, the Entity Equity Interests will be capable of being transferred to third party investors 112.

The swap agreement between the hedge counterparty 110 and the LLE investor 102 includes a number of terms, including the terms specifying the credit event as discussed above. For example, in some embodiments, the swap agreement may include the following terms:

| Term | Description |
|---|---|
| Swap | An identification of the LLE investor 102 will be |
| Counterparty | provided. |
| Swap | Terms will be provided specifying the swap transaction. |
| Transaction | Pursuant to some embodiments, the hedge counterparty |
| | 110 enters into a credit default swap agreement with the |
| | LLE investor 102 (also known as the swap counterparty). |
| | Pursuant to the transaction, hedge counterparty 110 |
| | receives (from LLE investor 102) a premium amount at a |
| | specified rate per annum of the notional amount, payable |
| | on specified payment dates. Upon the occurrence of a |
| | credit event, hedge counterparty 110 will liquidate the |
| | collateral and pay the proceeds to LLE investor 102. LLE |
| | investor 102 will transfer the Entity Equity Interests to |
| | hedge counterparty 110 (who then transfers the Entity |
| | Equity Interests to third party investors 112 pursuant to |
| | the terms of the note). |
| Notional | A notional amount will be specified in an amount equal to |
| Amount | the outstanding principal amount of the notes. |
| Deliverable | The swap agreement will specify a Deliverable |
| Obligation | Obligation. Pursuant to some embodiments, the |
| | Deliverable Obligation is the Entity Equity Interests 104. |
| Reference | A reference entity will be specified. Pursuant to some |
| Entity | embodiments, the reference entity is Lessee 108. |
| Reference | A reference obligation will be specified. Pursuant to some |
| Obligation | embodiments, the reference obligation is the Deliverable |
| | Obligation. |

Reference is now made to FIG. 3, where a further transaction 300 pursuant to some embodiments is shown. As with the embodiments described above, transaction 300 includes interaction between several parties to create a credit hedging transaction. In particular, transaction 300 includes interaction between LLE investor 102, Entity 104, Lessee 108, and a hedge counterparty 110. In the embodiment depicted in FIG. 3, hedge counterparty 110 is a financial institution or other entity issuing a letter of credit to LLE investor 102 or the Entity 104 to create a hedge for LLE investor's 102 investment in Entity 104. More particularly, the letter of credit provides a hedge against credit risk of loss in the amount of the LLE investor's 102 “equity termination value” (ETV). As such, the letter of credit between hedge counterparty 110 and LLE investor 102 will be referred to as the “ETV letter of credit”.

In general, the ETV letter of credit protects LLE investor 102 on its ETV at any point in time during the term of the Lease upon the occurrence of one of a specified credit event (as discussed above). Pursuant to a reimbursement agreement with Lessee 108, hedge counterparty 110 has a claim against all of the assets of Lessee 108 for any payment made under the ETV letter of credit. This effectively provides the hedge counterparty 110 with a claim on par with other secured creditors of the Lessee. In addition, hedge counterparty 110 succeeds to all rights of LLE investor 102 as holder of the Entity Equity Interests.

Transaction 300 also includes the participation of one or more lender/deficiency letter of credit providers 114 (hereinafter, simply “lender 114”) to provide non-recourse debt and a deficiency letter of credit to Entity 104. For example, pursuant to some embodiments, the non-recourse debt of Entity 104 is issued in a package with a deficiency letter of credit. The parties agree to a price for the package of non-recourse debt and deficiency letter of credit, and Entity 104 pays the price over the term of the package. Upon of the occurrence of a specified credit event, lender 114 is able to foreclose on the Assets and seek a deficiency payment under the deficiency letter of credit. Lender 114, pursuant to a reimbursement agreement with Lessee 108, has a claim against all of the assets of Lessee 108 for any payment made under the deficiency letter of credit. This effectively provides lender 114 with a claim on par with other secured creditors of the Lessee. In addition, lender 114 maintains all rights as non-recourse debt holder under the Lease.

Other terms may be specified. For example, the ETV letter of credit may specify terms associated with a change of control of Lessee 108. For example, if a successor entity's credit ratings fall below a defined threshold, either (a) the premium on the ETV letter of credit will be adjusted using a defined formula, or (b) Lessee 108 must replace the ETV letter of credit provider with another provider satisfactory to LLE investor 102. Other terms may impose one or more transfer restrictions.

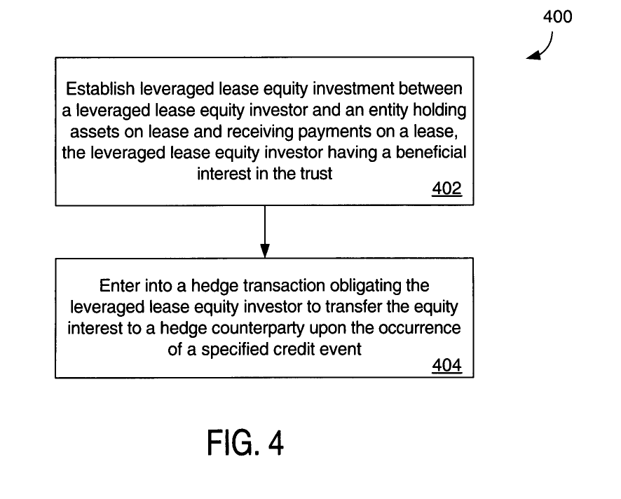

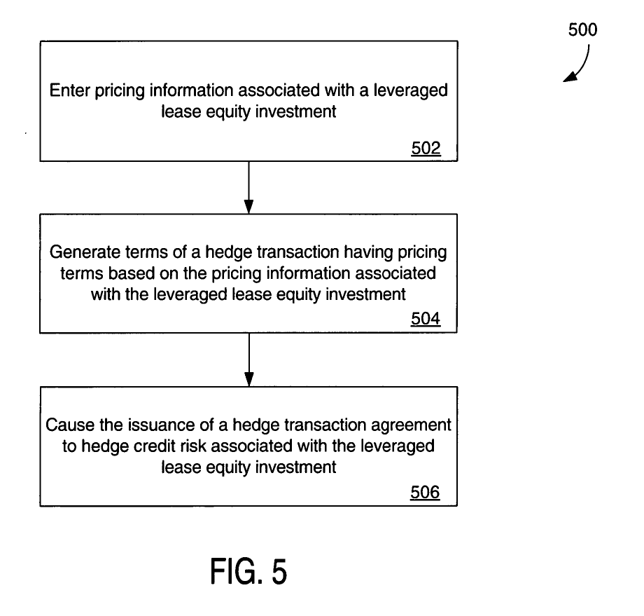

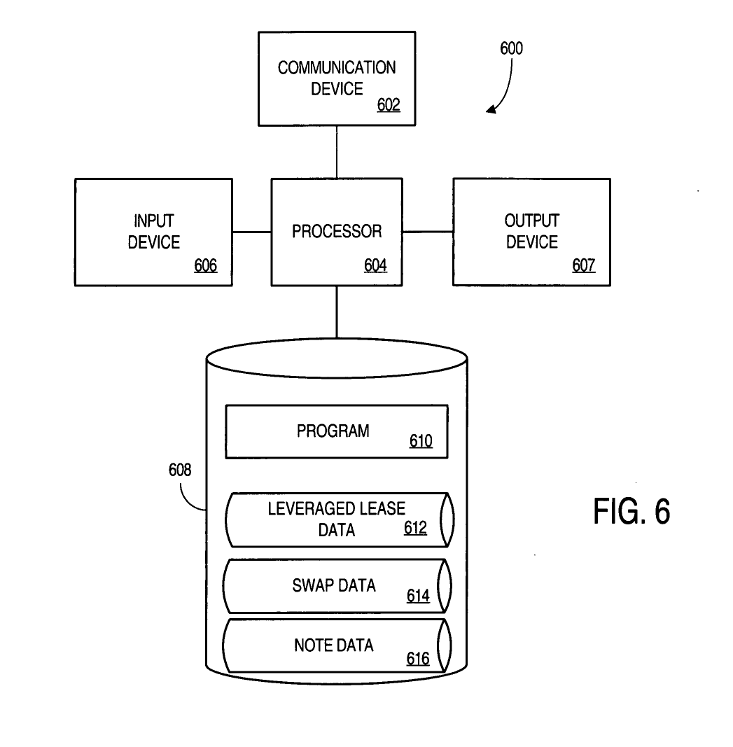

Further features of some embodiments will now be described by reference to FIGS. 4 and 5 in which flow diagrams are presented depicting transaction processes pursuant to some embodiments. Each of the process blocks of the flow diagrams (and other process steps discussed herein) may be performed in any reasonable order and need not be performed in the sequence shown. In some embodiments, some or all of the processing, accounting for, tracking, analyzing, pricing, reporting, recording, clearing, netting, recognizing or identifying the transaction or its steps or processes may be performed using one or more computing devices configured to perform the processing described herein. For example, as will be described in further detail below, some or all of the processing may be performed using a computing device such as the device 600 depicted in FIG. 6.

Processing associated with FIGS. 4 and 5 will be described in conjunction with an illustrative example based on the embodiment of FIG. 2. In the illustrative example, LLE investor 102 wishes to utilize features of embodiments of the present invention to hedge credit risk associated with a particular LLE transaction. In the illustrative example, a $1 billion LBO transaction has taken place, incorporating $190 mm of lease financing. The lease financing is performed through an Entity 104 created for this purpose. The Entity 104 is formed to have $142 mm of Lease debt and $48 mm of LLE. The Lease debt is senior non-recourse debt sold to third party lenders and are secured by the Assets of the Entity 104 and are non-recourse to the LLE investor 102. The LLE investor 102 contributes $48 mm in exchange for the Entity Equity Interests. The Lessee will enter into a Lease of Assets to the Entity 104. Lease rental payments will primarily be used to make debt service payments on the Lease debt and limited “free cash” payments to the LLE investor 102.

Now, pursuant to some embodiments, the LLE investor 102 wishes to hedge the credit risk associated with its Entity Equity Interests. Prior to Applicants' invention, few, if any, efficient hedges were available for this type of transaction. Referring first to FIG. 4, transaction process 400 to establish a credit risk hedge for LLE investor 102 will be described. Transaction process 400 begins at 402 where a LLE investment between an LLE investor 102 and Entity 104 holding Assets on Lease and receiving payments on a Lease is established. The LLE investor 102 is provided with the Entity Equity Interests.

Processing continues at 404 where the LLE investor 102 enters into a hedge transaction obligating the LLE investor 102 to transfer the Entity Equity Interests to a hedge counterparty 110 upon the occurrence of a specified credit event. In the embodiment described in conjunction with FIG. 2 above, the LLE investor 102 enters into a swap transaction obligating the LLE investor 102 to transfer the Entity Equity Interests to a hedge counterparty 110 upon the occurrence of a specified credit event. In some embodiments, the process may continue with the hedge counterparty's 110 issuance of a note to (one or more) third party investors 112 in exchange for payment of a principal amount. The note is secured by an amount of collateral and by a commitment to transfer the Entity Equity Interests to the third party investors 112 upon the occurrence of the specified credit event.

In the example, the LLE investor 102 is exposed to credit risk associated with its $48mm investment in the leveraged lease. As such, the LLE investor 102 desires to create an efficient hedge against this risk. An efficient hedge is one that reduces the LLE investor's 102 exposure. Accordingly, the hedge counterparty 110 issues a credit linked note or obligation to investors 112 with a face amount equal to the LLE investor's 102 ETV. The note has a coupon of LIBOR plus a premium amount agreed to by the parties (e.g., some agreed-upon number of basis points). The coupon on the note is, in some embodiments, equal to the yield from collateral purchased by the hedge counterparty 110 plus a premium amount paid by the LLE investor 102 on the swap transaction. Here, as an example, the hedge counterparty 110 has purchased collateral from the market yielding LIBOR flat, and the LLE investor 102 has agreed to pay a premium (e.g., some agreed-upon number of basis points) on the swap agreement. In some embodiments, the collateral yield and the premium are passed through to the third party note investors 112.

As discussed above, both the note and the swap agreement are written having default provisions such that, upon the occurrence of a specified credit event, the hedge counterparty 110 will liquidate the collateral and receive proceeds equal to the ETV. Those skilled in the art will appreciate that the ETV may be less (or more) than the original equity investment amount (here, less than $48 mm). The LLE investor 102 will deliver the Entity Equity Interests in exchange for cash from the hedge counterparty's 110 collateral proceeds. The hedge counterparty 110 will deliver the Entity Equity Interests to the third party note investors 112. In this manner, embodiments allow the LLE investor 102 to create a hedge of the LLE investment that was previously unavailable. Pursuant to some embodiments, the hedge is tailored to adapt to the changing exposure of the LLE investor 102 (e.g., as the ETV changes through the term of the Lease).

Referring now to FIG. 5, a further transaction 500 will now be described. Transaction 500 may be performed using one or more computing devices to evaluate, price and configure a credit risk hedge transaction pursuant to some embodiments. For example, process 500 may be performed prior to process 400 to allow the parties to a credit risk hedging transaction to evaluate the transaction. Process 500 may also be used to generate transaction documents in an automated or partially automated fashion which include the specific terms and conditions to effectuate the transaction

Processing begins at 502 where an individual or entity (such as a broker, agent, or the like) enters pricing information associated with a LLE investment. The pricing information may include information such as the total amount of the LLE investment. In the illustrative example, the amount of LLE investor's 102 investment ($48 mm) may be input. At 504, processing continues with the generation of terms of a hedge transaction having pricing terms based on the pricing information associated with the LLE investment. For example, processing at 504 may include generating swap documents including appropriate language and generating a payment obligation based on the amount entered at 502 (in the example, a payment obligation of $48 mm). A premium amount is also calculated and incorporated into the transaction documents.

Processing continues at 506 with the issuance of a hedge transaction agreement (or agreements) to hedge credit risk associated with the LLE investment. For example, processing at 506 may include generating note documents including appropriate language and generating the face and coupon amounts based on the information input or generated at 502 and 504. In the illustrative example, the face amount is set to $48 mm and the coupon is made equal to a yield from eligible collateral identified by the process plus the premium amount received from the LLE investor 102. Both the note and the swap agreement are generated with terms that ensure proper and similar treatment upon default of the LLE.

As discussed above, in the illustrative example, the LLE investor 102 has created an efficient hedge against credit risk associated with the investment, ensuring the LLE investor 102 is not exposed to credit risk of loss of its $48 mm LLE investment.

Pursuant to some embodiment, some or all of the processes of FIGS. 4 and 5 may be performed using one or more computing devices. Similarly, any of the participants (such as an administrator or agent of hedge counterparty 110) may utilize one or more computing devices to evaluate, price, administer, or manage credit hedge transactions issued pursuant to embodiments described herein. As another example, an agent or broker acting on behalf of LLE investor 102 may operate one or more computing devices to perform pricing and risk scenarios to determine whether a particular credit hedge transaction is desirable.

For example, referring now to FIG. 6, a computing device such as device 600 may be utilized. In some embodiments, device 600 is operated by an agent, administrator or other individual acting on behalf of an entity to assist in, evaluate, or direct the issuance or creation of a credit hedge transaction pursuant to embodiments disclosed herein. For example, in some embodiments, device 600 is operated by, or on behalf of, a hedge counterparty 110 or LLE investor 102 to price and identify terms associated with the issuance of a note and swap as described herein. As another example, in some embodiments, device 300 may be operated by, or on behalf of, LLE investor 102 to evaluate, price or analyze a credit hedge transaction pursuant to embodiments of the present invention.

As depicted, device 600 includes a computer processor 604 operatively coupled to a communication device 602, a storage device 608, an input device 606 and an output device 607. Communication device 602 may be used to facilitate communication with, for example, other devices and other participants (such as, for example, devices operated by or on behalf of hedge counterparties, lenders, issuers, agents, LLE investors, etc.).

Input device 606 may comprise, for example, one or more devices used to input data and information, such as, for example: a keyboard, a keypad, a mouse or other pointing device, a microphone, knob or a switch, an infra-red (IR) port, etc.

Output device 607 may comprise, for example, one or more devices used to output data and information, such as, for example: an IR port, a docking station, a display, a speaker, and/or a printer, etc.

Storage device 608 may comprise any appropriate information storage device, including combinations of magnetic storage devices (e.g., magnetic tape and hard disk drives), optical storage devices, and/or semiconductor memory devices such as Random Access Memory (RAM) devices and Read Only Memory (ROM) devices.

Storage device 608 stores one or more programs 610 or rule sets for controlling processor 604. Processor 608 performs instructions of program 610, and thereby operates in accordance with aspects of the present invention. In some embodiments, program 610 includes pricing rules used to evaluate or select terms associated with credit hedge transactions performed pursuant to embodiments described herein. In some embodiments, program 610 includes rules used to create and analyze terms of a swap transaction and a note transaction. In some embodiments, program 610 includes rules used to create and analyze terms of the swap and note transactions based on information input regarding a LLE investment.

In some embodiments, program 610 may be configured as a neural-network or other type of program using techniques known to those skilled in the art to achieve the functionality described herein.

Storage device 608 also stores one or more databases, including, for example, leveraged lease data 612, swap data 614, note data 616, etc. This information may be used, for example, to price, evaluate, analyze, create or administer credit hedge transactions pursuant to embodiments disclosed herein. For example, leveraged lease data 612 may include information associated with a particular LLE investment that a LLE investor 102 desires to hedge. Some or all of the swap data 614 may include data generated by device 600 in response to the entry of leveraged lease data 612. For example, swap data 614 may include pricing terms that are generated to hedge against credit risk associated with a credit event occurring in a particular LLE investment. Some or all of the note data 616 may be generated in by device 600 in response to the entry of leveraged lease data 612. For example, note data 616 may include pricing terms that are generated to hedge against credit risk associated with the leveraged lease (and in conjunction with the issuance of the swap). Storage device 608 may also store a number of terms and conditions that may be used to generate a swap agreement and a note agreement pursuant to the present invention. Other data, programs, and rules may also be used in conjunction with embodiments disclosed herein.

Although the present invention has been described with respect to a preferred embodiment thereof, those skilled in the art will note that various substitutions may be made to those embodiments described herein without departing from the spirit and scope of the present invention. Further, those skilled in the art will appreciate that embodiments provide advantages to various participants. For example, embodiments allow a hedge counterparty 110 or letter of credit issuer to assert a claim against the Lessee under the agreement pari passu to all other secured lenders, thereby providing the hedge counterparty 110 with a desirable claimant position. Participants also enjoy certainty associated with the definition of specified credit events that automatically cause the transfer of Entity Equity Interests.

1. A method for performing a transaction, comprising:
identifying an entity, said entity holding assets on lease and receiving rent payments on a lease, said entity having a beneficial interest owned by a leveraged lease equity investor; and
establishing an agreement between said leveraged lease equity investor and a hedge counterparty, said agreement identifying a credit event associated with said lease and obligating said leveraged lease equity investor to deliver said beneficial interest to said hedge counterparty upon the occurrence of said credit event.

2. The method of claim 1, further comprising:
establishing a second agreement between said hedge counterparty and third party investors, said second agreement obligating said hedge counterparty to deliver said beneficial interest to said third party investors upon the occurrence of said credit event.

3. The method of claim 1, wherein said hedge counterparty is unaffiliated with a party to the leveraged lease transaction.

4. The method of claim 1, wherein said agreement is a swap agreement.

5. The method of claim 1, wherein said agreement between said leveraged lease equity investor and said hedge counterparty is a letter of credit

6. The method of claim 1, wherein said credit event is a readily ascertainable event indicating a credit loss.

7. The method of claim 6, wherein said credit event is substantially short in time.

8. The method of claim 7, wherein said credit event is at least one of:
(a) a Chapter 11 bankruptcy and notice of lease termination by entity or lease debt holders;
(b) a Chapter 11 bankruptcy and rejection of said lease by a lessee;
(c) a failure to pay rent by the lessee and a notice of lease termination by entity or lease debt holders; or
(d) a Chapter 7 liquidation of lessee.

9. The method of claim 2, wherein said second agreement is a credit linked instrument having a face amount equal to an amount paid by said leveraged lease equity investor for said beneficial interest.

10. The method of claim 9, wherein said credit linked instrument is at least one of a note or a loan.

11. The method of claim 9, wherein said credit linked instrument pays a coupon amount equal to a yield from collateral purchased by said hedge counterparty and a premium amount paid on said agreement between said leveraged lease equity investor and said hedge counterparty.

12. The method of claim 11, wherein said agreement obligates said hedge counterparty to redeem said collateral and deliver proceeds to said leveraged lease equity investor upon the occurrence of said credit event.

13. A method for issuing a note to hedge risk of credit loss in a leveraged lease equity investment, comprising:
entering into a credit default swap obligating an leveraged lease equity investor to transfer an equity interest in a leveraged lease equity investment upon the occurrence of a specified credit event associated with the leveraged lease investment; and
issuing a note to a third party investor in exchange for payment of a principal amount, the note secured by an amount of collateral and by a commitment to transfer said leveraged lease equity interest to said third party investor upon the occurrence of said specified credit event.

14. A method, comprising:
entering into an agreement with a hedge counterparty, said agreement specifying a credit event upon which the hedge counterparty will deliver a beneficial interest in a trust holding assets on lease; and
issuing an instrument to a third party investor, said instrument secured by a security interest in defined collateral and a right by said third party investor to receive said beneficial interest upon occurrence of said credit event.

15. A system, comprising:
a processor; and
a storage device in communication with said processor and storing instructions adapted to be executed by said processor to:
identify a entity, said entity holding assets on lease and receiving payments on a lease, said entity having a beneficial interest owned by a leveraged lease equity investor;
establish an agreement between said leveraged lease equity investor and hedge counterparty, said agreement identifying a credit event associated with said lease and obligating said leveraged lease equity investor to deliver said beneficial interest to said hedge counterparty upon the occurrence of said credit event; and
establish a second agreement between said hedge counterparty and a third party investor, said second agreement obligating said hedge counterparty to deliver said beneficial interest to said third party investor upon the occurrence of said credit event.
